(19) United States
(12) Patent Application Publication
(10) Pub. No.: US 2024/0310487 A1
(43) Pub. Date: Sep. 19, 2024

(54) Aligned sensor

(71) Applicant: SICK AG, Waldkirch (DE)

(72) Inventors: Ralf Ulrich NÜBLING, Waldkirch (DE); Jonathan PFEIL, Waldkirch (DE)

(21) Appl. No.: 18/603,437

(22) Filed: Mar. 13, 2024

(30) Foreign Application Priority Data
Mar. 17, 2023 (DE) 102023106750.8

(51) Int. Cl. G01S 7/481

(52) U.S. Cl. CPC G01S 7/4812; G01S 7/4813

(57) ABSTRACT

A sensor module for a sensor is provided that has a sensor unit having a detection direction and a detection height as well as a module housing having at least a first outer wall for arranging at a planar base surface, whereby then an orientation and a height position of the module housing and thus the detection direction and detection height of the sensor unit are fixed. In this respect, the first outer wall has a three-dimensional contour here that is adapted to the individual detection direction and/or detection height of the sensor unit and tolerances of the sensor unit in the detection direction and/or detection height is/are compensated by the three-dimensional contour on an arrangement of the first outer wall at a planar base surface.

The invention relates to a sensor module for a sensor, in particular an optoelectronic sensor module for an optoelectronic sensor, and to a method of manufacturing an aligned sensor module.

There are sensors that are based on the most varied sensor principles and that require an alignment at their operating site. Optical detection principles are used as an example in the following in which the alignment has to be particularly precise as a rule. A widespread optoelectronic sensor is the laser scanner that is suitable for detections and distance measurements that make a large horizontal angular range of the measurement system necessary. In a laser scanner, a light beam generated by a laser periodically sweeps over a monitored zone with the help of a deflection unit. The light is remitted at objects in the monitored zone and is evaluated in the laser scanner. A conclusion is drawn on the angular location of the object from the angular position of the deflection unit and additionally on the distance of the object from the laser scanner from the time of flight while using the speed of light in a phase method or pulse method. The location of an object in the monitored zone is detected in two-dimensional polar coordinates using the angular data and the distance data. The positions of objects can thus be determined or their contour can be determined.

In addition to such measurement applications, laser scanners are also used in safety technology for monitoring a hazard source, such as a hazardous machine. Such a safety laser scanner is known from DE 43 40 756 A1. In this process, a protected field is monitored which may not be entered by operators during the operation of the machine. If the laser scanner recognizes an unauthorized protected field intrusion, for instance a leg of an operator, it triggers an emergency stop of the machine. Sensors used in safety technology have to work particularly reliably and must therefore satisfy high safety demands, for example the EN13849 standard for safety of machinery and the machinery standard EN61496 for electrosensitive protective equipment (ESPE).

Laser scanners are made up of a plurality of single parts subject to tolerances. As a result, production fluctuations result for light exit and scan plane. The height and alignment of the scan plane vary to a certain extent from unit to unit. For cost reasons, it is not always possible to keep the tolerances in the laser scanner so small from the start that the individual fluctuations are not disruptive. This makes a manual alignment necessary in installation in most applications. The alignment has to be repeated on a later replacement of the laser scanner. In addition, mounts are necessary that make an alignment possible at all. Such mounts are expensive and require additional construction space.

It is known to provide a unit with feet that are adjustable in height. However, this is only an example for a just named mount that makes an alignment possible. The alignment itself is not completed thereby and such feet always contain the risk that the alignment is lost by wanted or unwanted manipulation in the course of operation.

DE 20 2015 106 370 U1 discloses a further example of a mount for aligning a laser scanner. The already installed laser scanner can still be rotated by means of a meshing of two mount parts. Respective adjustable mounts for a projector are known from EP 1 852 646 A2 and US 2009/2494619. The above-named disadvantages are not overcome by any of these mounts.

It is therefore the object of the invention to improve the alignment of a sensor.

This object is satisfied by a sensor module for a sensor, in particular an optoelectronic sensor module for an optoelectronic sensor, and by a method of manufacturing an aligned sensor module in accordance with the respective independent claim. An assembly in which the actual sensor elements are combined is called a sensor module It can here, for example, be a transmission/reception assembly for the sensor signals. The sensor module comprises a sensor unit. This is now the functional heart of the sensor module, with the more precise design depending on the respective sensor principle and sensor type. With an optoelectronic sensor, the sensor unit can, for example, have a simpler light receiver, possibly combined with a light transmitter. The sensor unit has a detection direction and a detection height by which the alignment can be characterized. In an optoelectronic sensor, this corresponds, for example, to the orientation of the optical axis and the height of its passage point from the sensor or into the sensor. With a camera, a description is thus made of the height at which its field of view is and how it is aligned. With an active optoelectronic sensor, for instance a light scanner, the two values describe the orientation of the scan beam and the height of the light exit with respect to the sensor.

The sensor module further comprises a module housing in which the sensor unit is located. The term “module housing” is initially to be understood widely here. In accordance with the invention, it is a first outer wall of the module housing that is important that can be designed only as a pedestal, for example. The module housing only preferably comprises further housing walls or outer walls that make it a housing in the narrower sense and that preferably surround the sensor unit on all sides. It is conceivable that in addition to the first outer wall, at least one further outer wall can take over its role, for instance if the sensor module can selectively be installed at the right or at the left on a wall or in an over-housing or can, for instance, be placed on its head.

The orientation and height position of the module housing and thus the detection direction and detection height of the sensor unit are fixed by arranging the first outer wall at a planar base surface. Depending on the embodiment, the planar base surface is that of an over-housing or of an installation environment or setup environment. The sensor module is, for example, arranged with the first outer wall as a reference surface at any desired wall of the over-housing, preferably at the bottom. Or it is itself, without over-housing, placed on the floor on a workbench with the first outer wall as the lower side or is installed on a wall with the first outer wall as a rear wall or side wall. It must be pointed out in this connection that terms such as height and detection height are based on an upright orientation of the sensor with a horizontal planar base surface; with a side installation, the height is to be understood as a lateral distance from the then vertical planar base surface and accordingly with any other orientations of the sensor and the planar base surface.

The invention starts from the basic idea of providing the first outer wall with a three-dimensional contour that corrects the individual detection direction and/or detection height of the sensor unit on an arrangement at the planar base surface. The first outer wall has a planar extent to satisfy its function as an outer wall. The three-dimensional contour relates to a third dimension perpendicular to the planar extent that can be called the height or the thickness. Local portions of the three-dimensional contour provide a compensation of the detection direction and its total thickness provides a compensation of the detection height. Only the contact points and/or contact surfaces between the first outer wall and the planar base surface are relevant to the compensation function here; the three-dimensional contour therebetween is ultimately arbitrary and can, for example, have smaller or larger recesses. Embodiments having a full surface contact, only a few support points, preferably three support points, and any desired mixed forms having a planar and/or point contact are accordingly conceivable. The three-dimensional contour only corrects the detection direction, only the detection height, or both depending on the embodiment.

Each sensor module has an individual detection direction and detection height due to production tolerances. To compensate this, a corresponding individual three-dimensional contour results with a deviation from a conventional planar outer wall in shape and/or thickness. The three-dimensional contour is in particular inverse to the individual deviations from a specified detection direction and/or detection height. If, for example, the sensor unit is inclined to the left in its housing, the first outer wall is preferably elevated to the left by the same degree to move the sensor unit into the horizontal specified in this example; correspondingly to the right or to the top and bottom for the vertical. For vertical compensation, the thickness or height of the first outer wall is decreased or increased by so much overall as the individual detection height to the top or bottom deviates from a specified detection height.

The three-dimensional contour of the sensor module is fixed for the sensor module and is not configured for a further change. It is therefore not a question of adjustable screws or the like, but the three-dimensional contour is rather a fixed property of the first outer wall. It is nevertheless possible to act on the three-dimensional contour with a corresponding tool, but this is a destructive misuse and thus not a provided property of the sensor module.

The invention has the advantage that the alignment of a sensor is automatically ensured in the installation. In this respect, the installation effort is reduced and the alignment result is ensured. Individual differences within a product family are compensated; for example, all the laser scanners of a product family scan the same scan plane. Adjustable adjustment holders are no longer required. In the case of a sensor replacement, a new alignment is no longer required; the new unit takes over the role of its predecessor in accordance with the plug & play principle.

The module housing is preferably arranged in a sensor housing of the sensor, with the planar base surface being a wall of the sensor housing or being fixedly connected thereto. This takes up the already mentioned example of the arrangement in an over-housing. The planar base surface does not itself have to be a wall of the sensor housing; it is sufficient for it to be connected to it in a fixed location. Further components of the sensor such as evaluation electronics, a supply, or communication interfaces can be accommodated in the over-housing. Due to the invention, the sensor module can be installed as a very precise unit in the over-housing and thus in the complete sensor. The sensor is then aligned in itself; the tolerances discussed in the introduction are compensated.

The sensor module is alternatively itself already the sensor, with the module housing simultaneously acting as the sensor housing. The sensor module is identical to the sensor in this embodiment. There is accordingly no additional over-housing even though naturally no-one is prevented from again placing a complete sensor in an over-housing. The first outer wall with its three-dimensional contour provides that the sensor is aligned on a placement on the planar base surface or installation at the planar base surface.

The sensor is preferably a laser scanner or a radar having at least one scan plane whose orientation is fixed by the detection device. In this case, the three-dimensional contour can be understood very intuitively. It reproduces a slanted location of the scan plane in inverted form as a likewise slanted plane, with the three-dimensional contour, as mentioned, not having to be over the full area. A light transmitter generates, as already outlined in the introduction, transmitted light in a laser scanner and transmits it into the monitored zone. The transmitted light is received again as remitted transmitted light after it has been at least partly reflected back from an object in the monitored zone. A control and evaluation unit is preferably configured to determine a distance of the object from a time of flight between the transmission of the transmitted light and the reception of the received light. A scan movement, preferably a rotational movement, is produced with the aid of a moving deflection unit, by which scan movement the transmitted light and the received light are periodically transmitted at different deflection angles or are detected from different deflection angles. The scan plane is thereby scanned. There are multilayer scanners that have a plurality of transmitter/receiver pairs and so scan a plurality of scan planes; the detection direction then relates to a selected one of the scan planes. A radar works on this abstract description plane in exactly the same manner, with radar signals being generated and received instead of light.

The first outer wall is preferably integrated in the module housing. The first outer wall is therefore an integral component of the module housing overall. Without the first outer wall, the module housing would be open at this side. This is to be understood as an alternative to an intermediate piece to be presented directly.

The first outer wall preferably has an inner housing wall and an intermediate piece arranged thereon. The intermediate piece is arranged between the inner housing wall and the planar base surface. The inner housing wall is preferably configured as with a conventional housing, that is planer and of a uniform thickness with respect to the remaining module housing. The intermediate piece then has the three-dimensional contour. It is alternatively conceivable that the inner housing wall contributes to the three-dimensional contour.

The intermediate piece is preferably formed in one part. It is an installation metal sheet, for example. Such an intermediate piece can be manufactured inexpensively and is simple to handle.

The intermediate piece is preferably connected to the inner housing wall and is formed in multiple parts, in particular as a plurality of pins, disks, or tapped bushes of the same kind that are introduced into the inner housing wall to different extents. Such an intermediate piece is therefore not first brought into contact with the inner housing wall at the installation site, but is rather already fastened thereto. In principle, loose parts such as washers would also be conceivable; however, this is more difficult to handle and brings about a risk of confusion by which the alignment is not achieved after all. The intermediate piece can preferably have a separate part for every support point, preferably three support points. Each of these parts can have an individual height or can be shortened to an individual height. The parts are preferably of the same type among one another and are introduced into the inner housing wall or the module housing at different depths for a different effective height of the associated support points. It is conceivable to combine two or more support points in one part, for example using an elongated part having two support points and a small further part having the third support point.

The intermediate piece is preferably connected to the inner housing wall by mechanical interleaving, shape, pressing, magnetic force, screws, adhesive bonding, or welding. Hooks or a latch mechanism can be provided for a mechanical connection or a shape matched connection is produced by fitting. Other connections such as magnets, screws, bolts, adhesive bonding or welding are likewise possible.

The intermediate piece is preferably worked by material removal. The three-dimensional contour is thus so-to-say negatively imparted to a corresponding blank. Conversely, an additive process or a 3D printing is conceivable by which an intermediate piece is manufactured with the provided three-dimensional contour. In another respect, the three-dimensional contour can also be directly imprinted on the outer wall by an additive process and is then connected thereto. This can selectively be understood such that the outer wall then takes over the role of the inner wall and the imprint is that of the intermediate piece or that the outer wall together with the three-dimensional contour is an outer wall integrated in the housing without an intermediate piece.

In the method in accordance with the invention of manufacturing an aligned sensor module for a sensor, a sensor unit is first manufactured and is installed in a module housing having at least one first outer wall with the individual detection direction and detection height resulting from the component tolerances, installation tolerances, or other tolerances. The first outer wall of the unit is then arranged at a planar base surface and the individual detection direction and/or the individual detection height is/are measured to determine a deviation from a specified or desired detection direction or detection height therefrom. The first outer wall is then provided with a three-dimensional contour that compensates the deviations.

The module housing is preferably arranged in a sensor housing on a wall of the sensor housing or a reference surface that is fixedly connected thereto and that forms the planar base surface. A sensor highly precisely aligned in itself is thus produced. Alternatively, the sensor module is already the sensor and the module housing simultaneously acts as the sensor housing so that the sensor has already been manufactured with the sensor module.

The first outer wall is preferably manufactured with the module housing and completely as a part of the module housing. In this respect, the first touter wall in particular first has a material addition or material excess than is then partially removed to manufacture the three-dimensional contour. The material addition does not have to extend over the entire first outer wall; only a plurality of columns, legs, or pins can also be provided that are individually shortened to manufacture the three-dimensional contour with corresponding contact points.

The module housing is preferably first manufactured with an inner housing wall; an intermediate piece is manufactured with the three-dimensional contour and the intermediate piece is fastened to the inner housing wall or is arranged between the inner housing wall and the planar base surface so that the inner housing wall and the intermediate piece together form the first outer wall. The intermediate piece can therefore selectively already be connected to the module housing during the production or can first remain loose and only be placed below or therebetween at the operating site. An intermediate piece has the advantage that the sensor itself can remain unchanged and only an inexpensive intermediate piece is added.

The intermediate piece is preferably manufactured by material removal from a blank. In this respect, the three-dimensional contour is worked out of the blank, for example an installation metal sheet. Alternatively, the intermediate piece is manufactured by an additive process or by a 3D print, including the three-dimensional contour.

The intermediate piece is preferably provided with a marking from which the association with the sensor can be seen. This is above all of use in an embodiment in which the intermediate piece first remains loose. An unambiguous association of the intermediate piece with that sensor for which it was manufactured with its three-dimensional contour can be carried out in a simple manner by the marking. For example, a serial number of the sensor is suitable for this that is anyway as a rule on the module housing or at least in the associated documentation of the sensor. The marking can be directly applied to the intermediate piece, for example by laser engraving, but a print on an adhesive label or the like is also conceivable.

The intermediate piece preferably has a marking and/or structuring with reference to which it is attached in the correct orientation. The intermediate piece is typically not symmetrical, that is actually its purpose. A correct orientation is therefore required in the case of an intermediate piece that initially remains loose and equally on the attachment of the intermediate piece as part of the production. Certain sides of the intermediate piece can be marked by color or by symbols for this purpose. A basic shape is also conceivable that allows an unambiguous orientation to be recognized. Structurings are also possible on the provided connection side of the intermediate piece and the inner housing wall in a pattern that only produces a mutual engagement in a suitable orientation. The blank can already bear the marking or the structuring; unlike the marking of the previous paragraph it does not have to be individual. The three-dimensional contour is rather then manufactured to match the specified orientation.

The intermediate piece preferably has a plurality of parts that are similar among one another and that are introduced into the inner housing wall at different depths. Examples for this are pins or tapped bushes that are introduced so far that the overhang produces the desired three-dimensional contour. It is alternatively conceivable to manufacture or store a plurality of parts with different thicknesses or lengths and to connect a suitable selection to the inner housing wall. Again alternatively, a plurality of parts can remain loose, but this is not user friendly and is susceptible to error.

Reference is additionally made to the statements on the sensor in accordance with the invention with respect to further possible manufacturing steps and the advantages that result from the sensor manufactured thereby.

The invention will be explained in more detail in the following also with respect to further features and advantages by way of example with reference to embodiments and to the enclosed drawing. The Figures of the drawing show in:

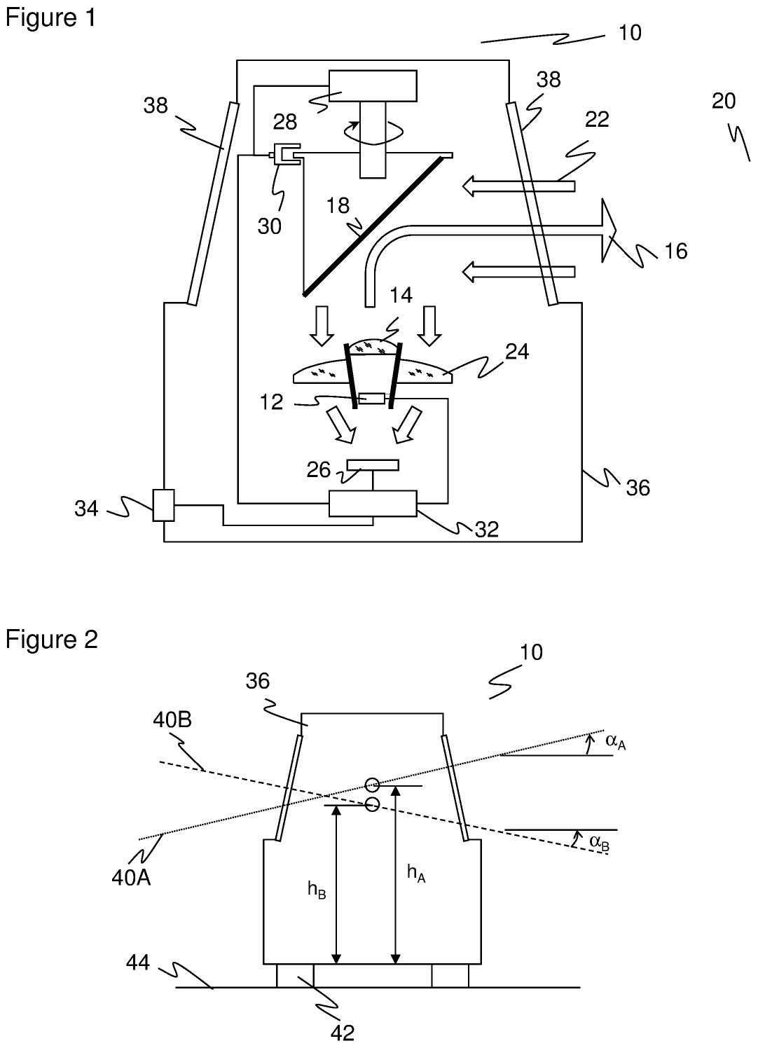

FIG. 1 a schematic representation of a laser scanner;

FIG. 2 a schematic representation of a laser scanner with an illustration of different possible scan planes due to production tolerances;

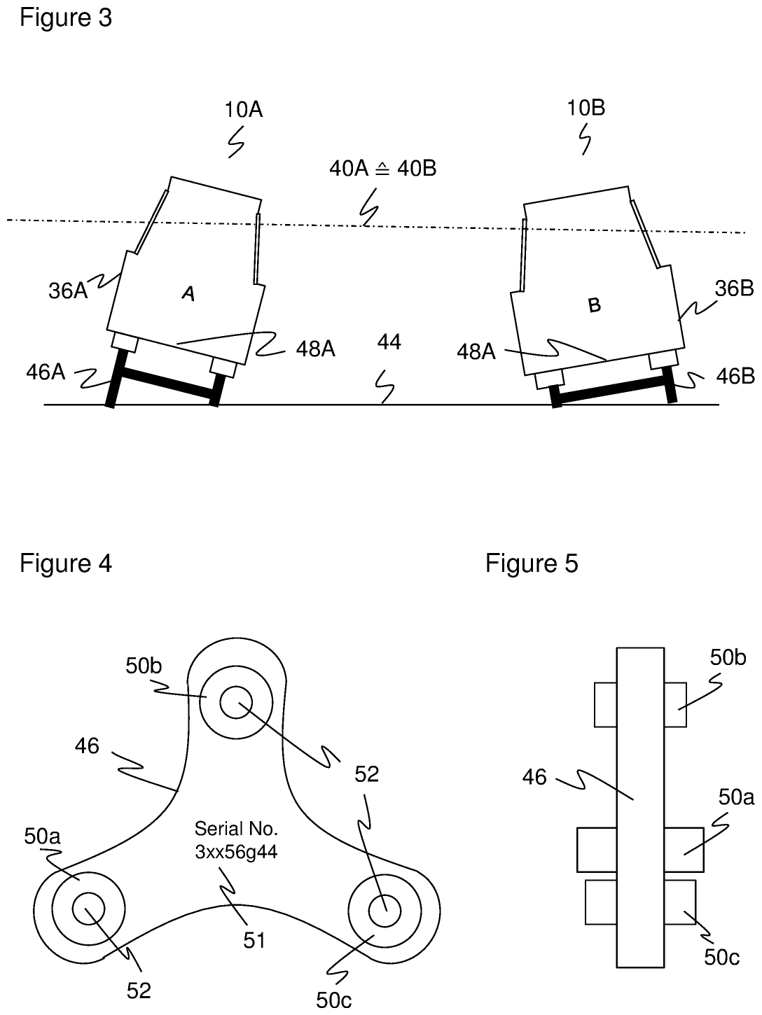

FIG. 3 a schematic representation of two laser scanners, each with an individual intermediate piece for compensating the misalignments resulting from production tolerances;

FIG. 4 a plan view of an exemplary compensating intermediate piece;

FIG. 5 a side view of FIG. 4;

FIG. 6 a plan view of an exemplary multipart compensating intermediate piece;

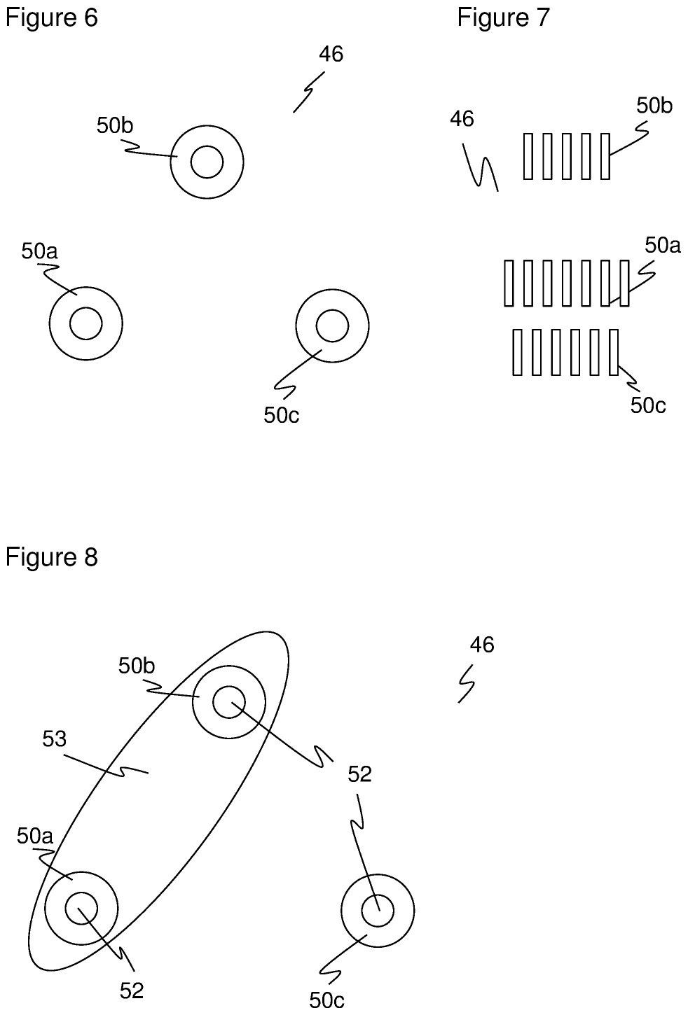

FIG. 7 a side view of FIG. 6;

FIG. 8 a plan view of a further multipart compensating intermediate piece;

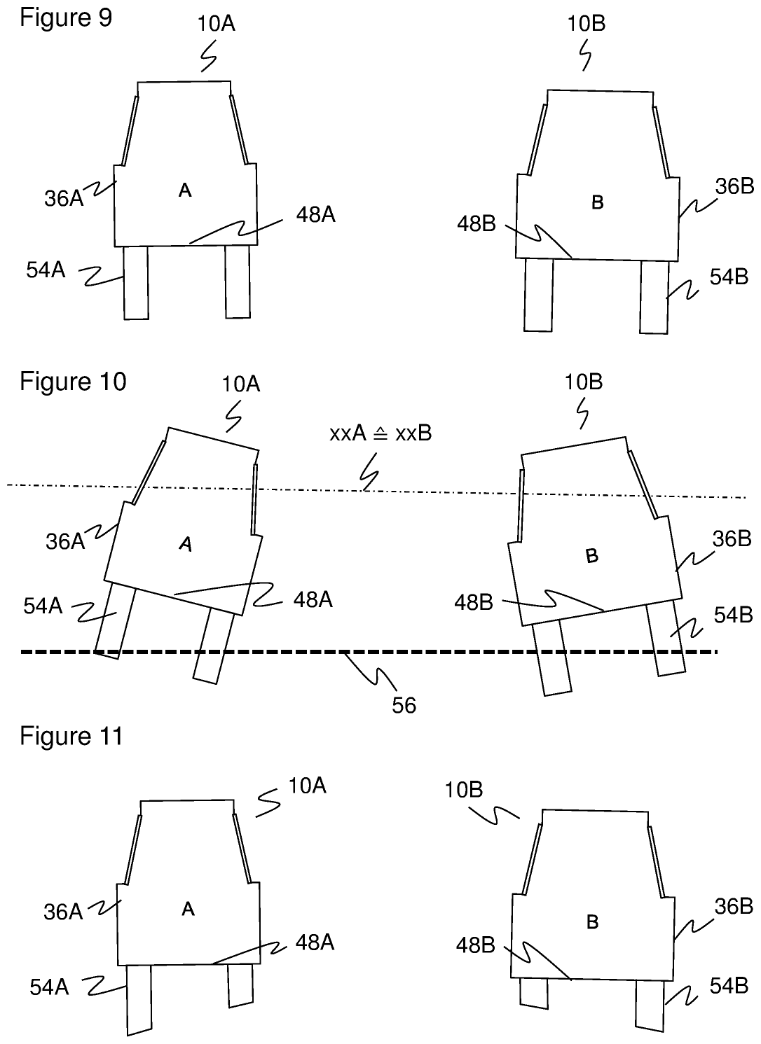

FIG. 9 a schematic representation of two laser scanners with additional production tolerances in a starting situation with long, not yet adapted legs;

FIG. 10 a representation corresponding to FIG. 9 with a respective alignment of the two laser scanners compensating the individual production tolerances;

FIG. 11 a representation corresponding to FIG. 10 of the two laser scanners with individually shortened legs corresponding to the required compensating alignment;

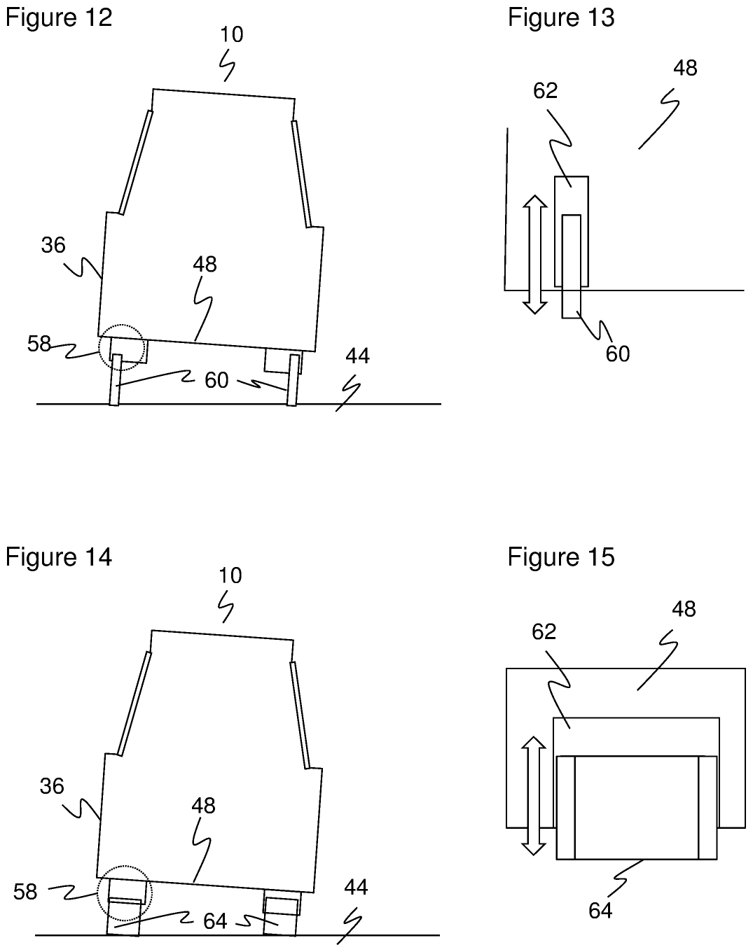

FIG. 12 a schematic representation of a laser scanner with pins that are pressed in to different depths for the alignment;

FIG. 13 a detail view of FIG. 12 of the region with a pressed-in pin;

FIG. 14 a schematic representation of a laser scanner with tapped bushes that are pressed in at different depths for the alignment; and

FIG. 15 a detail view of FIG. 14 of the region with a pressed-in tapped bush.

FIG. 1 shows a schematic sectional representation through a laser scanner 10. A light transmitter 12, for example having a laser light source, generates a transmitted light beam 16 with the aid of a transmission optics 14. The transmitted light beam 16 is transmitted into a monitored zone 20 by means of a deflection unit 18. To avoid optical cross-talk, the transmitted light beam 16 can be at least partly surrounded by a transmission tube, not shown.

The transmitted light beam 16 is remitted by an object that may be present in the monitored zone 20. The corresponding received light 22 again arrives back at the laser scanner 10 and is detected by a light receiver 26 via the deflection unit 18 by means of an optical reception optics 24. The reception optics 24 is preferably a single converging lens, but further lenses and other optical elements can be added. The light receiver 26, for example, has at least one photodiode or, for higher sensitivity, an avalanche photodiode (APD) or an arrangement having at least one single photon avalanche diode (SPAD. SiPM).

The deflection unit 18 is set into a continuous rotational movement having a scan frequency by a motor 28. The transmitted light beam 16 thereby scans one plane during each scan period, that is on a complete revolution at the scanning frequency. An angle measurement unit 30 is arranged at the outer periphery of the detection unit 18 to detect the respective angular position of the detection unit 18. The angle measurement unit 30 is here formed by way of example by an encoder wheel as an angular standard and by a forked light barrier as a scanning device.

A control and evaluation unit 32 is connected to the light transmitter 12, to the light receiver 26, to the motor 28, and to the angle measurement unit 30. A conclusion is drawn on the distance of a scanned object from the laser scanner 10 using the speed of light by determining the time of flight between the transmission of the transmitted light beam 16 and the reception of remitted received light 22. The respective angular position at which the transmitted light beam 26 was transmitted here is known to the evaluation unit from the angular measurement unit 30.

Two-dimensional polar coordinates of the object points in the monitored zone 20 are thus available via the angle and the distance after every scan period and corresponding measured data can be transmitted via an interface 34. The interface 34 can conversely be used for a parameterization or other data exchange between the laser scanner 10 and the outside world. The interface 34 can be designed for communication in one or more conventional protocols such as IO link, Ethernet, Profibus, USB3, Bluetooth, wireless LAN, LTE, 5G and many others. In applications in safety engineering, the interface 34 can be configured as safe and can in particular be a safe output (OSSD, output signal switching device) for a safety-related shut-down signal on recognition of a protective field infringement. The laser scanner 10 is accommodated in a housing 36 that has a peripheral front screen 38.

In the laser scanner 10 shown, the light transmitter 12 and its transmission optics 14 are located in a central opening of the reception optics 24. This is only an exemplary possibility of the arrangement. The invention additionally comprises alternative coaxial solutions, for instance having their own mirror region for the transmitted light beam 16 or having beam splitters, and also biaxial arrangements. The laser scanner 10 can furthermore use a rotating measuring head in which the light transmitter 12 and/or the light receiver 26 rotate as a deflection unit instead of a rotating mirror. Again different designs of a laser scanner 10 do not only scan a single scan plane, but are rather configured as multi-beam and thus as multilayer scanners. One of the plurality of scan planes is used, in particular, where present, a central scan plane, for the alignment to be explained directly. A multilayer scanner has a plurality of transmitter/receiver pairs acting offset to one another in elevation, with a plurality of light beams, for example, being able to be generated by means of beam splitters or as a VCSEL array from a light source and/or received in a matrix array or specifically a SPAD array.

The invention will be described as representative with reference to a laser scanner 10. However, it also comprises other optoelectronic sensors, for example a light sensor whose scan beam has to be aligned, a light grid having a plurality of mutually parallel detection beams, or a 2D or 3D camera with an alignment of its field of view. Sensors are furthermore included that do not use an optical sensor principle. In this respect, a radar must first be mentioned that likewise scans a scan plane even if it is possibly delineated in a somewhat less strict manner in elevation. Further sensors, not named exclusively, are ultrasound sensors, capacitive, inductive, or magnetic sensors that all require a more or less precise alignment depending on the design and the application. The sensor in accordance with the invention can be configured as a safety sensor in the sense of the standards named in the introduction, in particular as a safety laser scanner, and can be used in safety engineering for accident avoidance, for example by monitoring protected fields or by evaluating the distance and speed of an object in the environment of a hazard source (speed and separation).

The laser scanner 10 of FIG. 1 is a complete sensor and the alignment with its housing 36 with respect to external, in particular a setup surface, wall, or the like, will be explained in the following for this example. The invention can additionally be used such that a sensor module such as a receiver assembly or a transmitter/receiver assembly can thereby be installed in a highly precise alignment in a sensor housing. The reference surface is then not external, but rather a wall or a reference surface of the sensor housing connected thereto. The alignment principle is the same in all variants and is thus analogously transferrable and is therefore not separately described.

FIG. 2 shows a schematic representation of a laser scanner 10 with an illustration of two different scan planes 40A-B due to production tolerances. Only the outer contours of a laser scanner 10 will be shown in the following; reference is made to the explanations on FIG. 1 for the further elements. The laser scanner 10 is arranged with a first outer wall 42 at a planar base surface 44. This is shown in FIG. 2 such that the lower side of the laser scanner 10 is on the floor. Any other side of the laser scanner 10 can equally be arranged at any differently oriented base surface 44; for example, on an installation with the lower side on the wall or with the upper side on the ceiling. That outer wall is meant by the first outer wall 42 that comes into contact with the planar base surface 44.

The scan plane 40A-B extends somewhat differently in every laser scanner 10 as a result of component tolerances, installation tolerances, or other tolerances, with FIG. 2 showing this in a clearly exaggerated manner. This is detected by two values. On the one hand, this is the orientation that is characterized by a detection direction. For the inclination of the scan plane 40A-B results from the irradiation direction of the transmitted light beam 16. This is specified, for example, as the angle CA, aB with respect to the base plane 44. On the other hand, it is a detection height ha , he that is measured from the light departure region against a reference such as the lower unit termination. The term height is based on the upright orientation shown in FIG. 2; with a vertical installation, it is a lateral spacing, correspondingly with any desired inclination of the planar base surface, and all this is simply called height. The detection direction and detection height varies among laser scanners 10 of the same design; they become an individual detection direction and an individual detection height due to tolerances. These differences require an alignment and are not desired, but cannot be avoided at the source by reducing tolerances for cost reasons.

FIG. 3 shows a schematic representation of two laser scanners 10A-B, each having an individual intermediate piece 46A-B for compensating the misalignments in the detection direction and/or detection height resulting from production tolerances. An intermediate piece 46A-B, for example an intermediate metal sheet, that compensates the inclination and the vertical offset of the scan planes 40A-B is individually produced for each of the laser scanners 10a-b. The two scan planes 40A-B thereby now correspond to one another. They are disposed at the same detection height and have the same detection direction, horizontal here. The intermediate piece 46A-B forms the first outer wall 42 together with the actual, inner housing wall 48A-B. In this respect, due to the intermediate piece 46A-B, the first outer wall now has a three-dimensional contour by which the individual misalignment of the respective laser scanners 10A-B in the detection direction and/or detection height is individually compensated.

To achieve a suitable intermediate piece 46A-B, the orientation of the scan plane 40A-B and/or the height of the light departure, that is the individual detection direction or individual detection height is measured for every individual laser scanner 10A-B, i.e. for every individual serial number. This is sometimes done during the final production. It may arbitrarily result that the tolerances have so little effect for a just measured individual laser scanner 10A-B that an improved alignment is not necessary. Otherwise, the suitable intermediate piece 46A-B is individually produced as required. The intermediate piece 46 can be manufactured by removal of material from a blank. Another possibility is an additive process such a 3D printing.

An individual adaptation or alignment takes place by arranging the intermediate piece 46 between the inner housing wall 48A-B and the planar base surface 44. All the laser scanners 10A-B of a product family can be moved to the same detection direction and/or detection height in this manner. This alignment is no longer manipulable intentionally or unintentionally, unlike, for example, adjustment screws or vertically adjustable feet. The intermediate piece 46 can first remain loose and only be interposed during the installation or it is already fastened to the laser scanner 10 beforehand, in particular during the final production. Any desired fastenings are conceivable for this purpose such as hooks, a magnetic force, screws, fitting, adhesive bonding, pressing, or (laser) welding.

FIG. 4 shows an exemplary intermediate piece 46 with a compensating three-dimensional contour in a plan view and FIG. 5 in a side view. To specify an unambiguous alignment, three contact points or support points 50a-c in accordance with the tripod principle are sufficient. There can nevertheless be further contact points, contact surface, or a full area contact in other embodiments. The support points 50a-c are also broadened into small areas in FIG. 4 and there is room in their interiors for a respective screw borehole 52 for fastening the laser scanner 10 to the planar base surface 44 by means of screws. In FIG. 5, the different heights of the support points 50a-c can be recognized that give the intermediate piece 46 the required three-dimensional contour.

The intermediate piece 46 is adapted to the individually measured detection direction and/or detection height. An unambiguous association of the intermediate piece 46 with the associated laser scanner 10 is therefore required. To facilitate this, the intermediate piece 46 can be marked by a sufficiently unambiguous identity code, for example a serial number 51 applied by laser engraving. In addition, the support points 50a-c have different heights as a rule so that the correct orientation of the intermediate piece 46 is not important. This can be ensured by shaping; alternatively by further markings, colors, or structurings. No individualization is required for a specification of the orientation; the three-dimensional contour can rather conversely be attached for a specific orientation. Specifications for the correct orientation can therefore be provided as the same for all the intermediate pieces 46 and can, for example, already be applied to a blank before the application of the three-dimensional contour.

FIG. 6 shows an alternative multipart intermediate piece 46 in a plan view and FIG. 7 in a side view. In principle, it is the support points 50a-c of FIGS. 4 to 5, but without connecting material for a common intermediate piece 46. Such an intermediate piece 46 uses less material. It is also possible to store and suitably select parts of the multipart intermediate piece 46 of different heights or to assemble them from similar parts as indicated in FIG. 7. These are all general possibilities for the individual alignment. The installation is, however, made more difficult because more parts have to be installed and it must above all be ensured that not only the correct parts set reaches the correct laser scanner 10, but that each part also reaches its provided position at the laser scanner 10. To limit the risk of confusion at least by controlled conditions and qualified personnel, a multipart intermediate piece 46 should be fastened to the laser scanner 10 before the laser scanner 10 is delivered to the operating site. An arrangement of a loose multipart intermediate piece 46 between the first outer wall 42 and the planar base surface 44 only during installation further increases the risk of confusion.

FIG. 8 shows a plan view of a further multipart compensating intermediate piece 46. Two support points 50a-b are here assembled on a common component 53; only the third support point 50c forms a separate component. This is a mixed form in which the advantages and disadvantages of a common component in accordance with FIGS. 4 and 5 and of a multipart component in accordance with FIGS. 6 and 7 come into play in a respectively weaker form.

FIGS. 9 to 11 show a further embodiment of the alignment of a laser scanner 10 by an individual compensating three-dimensional contour. In the starting state of FIG. 9, legs 58A-B with an excess dimension or an overlength and thus a kind of material reserve are attached to the inner housing wall 48A-B. These legs 54A-B are consequently already fixedly connected to the laser scanner 10 at the beginning or in an early phase of the manufacture prior to the individual adaptation. The first outer wall 42 is formed in this embodiment by the inner housing wall 48A-B and the legs 54A-B.

As already described, then or, for example, during the final production, the individual detection direction and/or individual detection height are measured. The inclinations and vertical displacements that are shown in FIG. 10 and are required for the alignment result from this. The legs 54A-B are now shortened corresponding to the shown dividing plane 56 in a mechanical reworking, for example by a cutting process or laser ablation. The dividing plane 56 is only an illustration of the required shortening and thus of the three-dimensional contour to be achieved. After this shortening of the legs 54A-B, the laser scanners 10A-B will adopt the required alignment corresponding to the dividing plane 56 with respect to a planar base surface 44 at the operating site. FIG. 11 shows the two laser scanners 10A-B again finally in the delivery state thus achieved. An intermediate piece 46 is not required in this embodiment.

FIG. 12 illustrates a further embodiment of the alignment, with FIG. 13 being a detail view of the detail marked by the circle 58 in FIG. 12. The three-dimensional contour with support points of different heights is achieved here in that pins 60 are pressed into a cutout 62 of the inner housing wall 48 at different depths. The pins 60 preferably originally have the same length, that is can be similar among one another, with alternatively pins of different lengths also being able to be used. The cutout 62 can be dispensed with depending on the materials and the force of the pressing. The pins 60 can additionally be fixed at the correct depth, for example by adhesive bonding or welding.

FIG. 14 illustrates a very similar embodiment of the alignment, with FIG. 15 being a detail view of the detail marked by the circle 58 in FIG. 14. Tapped bushes 64 are pressed into the inner housing wall 48 at different depths here instead of pins. It is thus also illustrated that pins 60 just like tapped bushes 64 only serve as examples for elements that can be introduced at different depths to effectively produce different heights of the support points.

1. A sensor module for a sensor that has a sensor unit having a detection direction and a detection height, as well as a module housing having at least a first outer wall for arranging at a planar base surface, whereby then an orientation and a height position of the module housing and thus the detection direction and detection height of the sensor unit are fixed, wherein the first outer wall has a three-dimensional contour that is adapted to the individual detection direction and/or detection height of the sensor unit and tolerances of the sensor unit in the detection direction and/or detection height are compensated by the three-dimensional contour on an arrangement of the first outer wall at a planar base surface.

2. The sensor module sensor module in accordance with claim 1,
wherein the sensor module is configured for an optoelectronic sensor.

3. The sensor module in accordance with claim 1,
wherein the module housing is arranged in a sensor housing of the sensor; and wherein the planar base surface is a wall of the sensor housing or is fixedly connected thereto.

4. The sensor module in accordance with claim 1,
wherein the sensor module is the sensor and the module housing simultaneously acts as a sensor housing.

5. The sensor module in accordance with claim 1,
wherein the sensor is a laser scanner or a radar having at least one scan plane whose orientation is fixed by the detection direction.

6. The sensor module in accordance with claim 1,
wherein the first outer wall is integrated into the module housing.

7. The sensor module in accordance with claim 1,
wherein the first outer wall has an inner housing wall and an intermediate piece arranged thereat.

8. The sensor module in accordance with claim 7,
wherein the intermediate piece is formed in one part.

9. The sensor module in accordance with claim 7,
wherein the intermediate piece is connected to the inner housing wall and is formed in multiple parts.

10. The sensor module in accordance with claim 7,
wherein the multiple parts are formed as a plurality of pins, disks, or tapped bushes of the same kind that are introduced into the inner housing wall to different extents.

11. The sensor module in accordance with claim 7,
wherein the intermediate piece is connected to the inner housing wall by mechanical interleaving, shape, pressing, magnetic force, screws, adhesive bonding, or welding.

12. The sensor module in accordance with claim 7,
wherein the intermediate piece is machined by material removal or is 3D printed.

13. A method of manufacturing an aligned sensor module for a sensor, in
which a sensor unit is manufactured and is installed in a module housing having at least one outer wall with an individual detection direction and detection height,
wherein the individual detection direction and/or the individual detection height is/are measured on an arrangement of the module housing with the first outer wall at a planar base surface; wherein a deviation of the individual detection direction from a desired detection direction and/or of the individual detection height from a desired detection height is/are determined and the first outer wall is provided with a three-dimensional contour that compensates the deviations.

14. The method in accordance with claim 13, wherein the sensor module has a sensor unit having a detection direction and a detection height, as well as a module housing having at least a first outer wall for arranging at a planar base surface, whereby then an orientation and a height position of the module housing and thus the detection direction and detection height of the sensor unit are fixed, wherein the first outer wall has a three-dimensional contour that is adapted to the individual detection direction and/or detection height of the sensor unit and tolerances of the sensor unit in the detection direction and/or detection height are compensated by the three-dimensional contour on an arrangement of the first outer wall at a planar base surface.

15. The method in accordance with claim 13,
wherein the module housing is arranged in a sensor housing on a wall of the sensor housing or a reference surface that is fixedly connected thereto and that forms the planar base surface.

16. The method in accordance with claim 13,
wherein the sensor module is the sensor and the module housing simultaneously acts as the sensor housing so that the sensor has already been manufactured with the sensor module.

17. The method in accordance with claim 13,
wherein the first outer wall is manufactured with the module housing and completely as part of the housing.

18. The method in accordance with claim 13,
wherein the first outer wall is manufactured with the module housing and completely as part of the housing originally with a material addition that is then partially removed to manufacture the three-dimensional contour.

19. The method in accordance with claim 13,
wherein the module housing is first manufactured with an inner housing wall, an intermediate piece is manufactured with the three-dimensional contour and the intermediate piece is fastened to the inner housing wall or is arranged between the inner housing wall and the planar base surface so that the inner housing wall and the intermediate piece together form the first outer wall.

20. The method in accordance with claim 19,
wherein the intermediate piece is manufactured by material removal from a blank.

21. The method in accordance with claim 19,
wherein the intermediate piece is manufactured by an additive process.

22. The method in accordance with claim 19,
wherein the intermediate piece is provided with a marking from which the association with the sensor can be seen.

23. The method in accordance with claim 19,
wherein the intermediate piece has a marking and/or structuring with reference to which it is attached in the correct orientation.

24. The method in accordance with claim 19,
wherein the intermediate piece has a plurality of parts that are similar among one another and that are introduced into the inner housing wall at different depths.
